(19) United States
(12) Patent Application Publication
(10) Pub. No.: US 2002/0001391 A1
(43) Pub. Date: Jan. 3, 2002

(54) Acoustic switch with electronic switching capability

(75) Inventor: Alexander L. Darbut, Edina, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Resistance Technology, Inc., Arden Hills, MN (US)

(21) Appl. No.: 09/809,744

(22) Filed: Mar. 15, 2001

Related U.S. Application Data
(60) Provisional application No. 60/189,954, filed on Mar. 16, 2000.

(51) Int. Cl. H04R 3/00; H04R 25/00; H04R 1/02

(52) U.S. Cl. 381/122; 381/123; 381/92; 381/322; 381/337

(57) ABSTRACT

A microphone construction for use in a hearing aid includes a housing with first and second acoustic passages in communication with a microphone retaining chamber and acoustic openings in an exterior surface. A microphone, disposed within the microphone retaining chamber, has a first acoustic port in an acoustic relationship with the first acoustic passage and a second acoustic port in an acoustic relationship with the second acoustic passage. A first and second set of electrical leads are disposed within the housing. A switching mechanism secured to the housing and is positionable between a first position and a second position. In the first position, the first and second acoustic passages are in an acoustic receptive state and a first electric circuit is completed by connecting the first set of leads with a first connecting element disposed within the switching mechanism while breaking a second circuit. In the second position, either the first or the second acoustic passage are in an acoustic receptive state while the other acoustic passage is acoustically plugged and a second connecting element within the switching mechanism completes a second electric circuit by connecting the second set of leads while breaking the first circuit.

### CROSS REFERENCE TO RELATED APPLICATIONS

This application claims priority of U.S. Provisional Patent Application No. 60/189,954.

### BACKGROUND OF THE INVENTION

The present invention relates to microphones for use in hearing aids. In particular, the present invention relates to microphone construction having a switching element capable of mechanically positioning the microphone into an omni-directional or directional mode while completing either a first electric circuit or a second electric circuit.

Hearing aids that have the capabilities of a directional microphone and an omni-directional microphone are advantageous to the user. In certain situations an omni-directional microphone is preferred to a directional microphone and vice versa. For example, in a reverberant environment or in an environment that has background noise, a directional microphone will improve speech intelligibility. Directional microphones are also preferred when the sound source is close to the hearing aid user. In addition, attenuation of sounds coming from the rear provide better listening comfort in a noisy environment. Likewise, in other environments, directionality may not be needed, and in fact, may be a detriment.

For purposes of this application, by directional microphone is meant a microphone having two physically separated acoustic ports which acoustically relate back to opposite sides of a microphone diaphragm. In contrast, an omni-directional microphone has only one acoustic port which acoustically relates to only one side of the microphone diaphragm.

In the past, two microphones have been included in hearing aids, one an omni-directional microphone and the other a directional microphone. The hearing aid user may switch electronically from one to the other. David Preves, Directional Microphone Use in ITE Hearing Instruments, The Hearing Review, July 1997; Olson et al., Performance of SENSO C9 Directional, Widexpress, July 1997. This type of hearing aid construction has the disadvantage of the cost of two microphones and the added space that two microphones require.

There have also been attempts to provide a hearing aid that permits the user to select between directional or omni-directional modes using one microphone. Such hearing aid constructions are described in the following patents:

| Inventor | U.S. Pat. No. |
|---|---|
| Killion | 3,835,263 |
| Johanson et al. | 3,836,732 |
| Johanson et al. | 3,909,556 |
| Cole | 4,051,330 |
| Berland | 4,142,072 |

However, the hearing aid constructions in the above mentioned patents are not conducive to a miniature-in-the-ear type of hearing aid construction since the switching mechanisms and the acoustic channels take up too much space.

Additionally, at times the user of the hearing aid may require more features than choosing between omni-directional and directional modes, such as an equalization circuit or a sound attenuation circuit. Previously, separate switches were required to provide the mechanical switching from an omni-directional mode to a directional mode and also to switch electric circuits on and off. The separate switches caused the hearing aids to become larger and as such are not conducive to miniature-in-the-ear hearing aid constructions.

### BRIEF SUMMARY OF THE INVENTION

The present invention includes a microphone constriction for use in a hearing aid having a housing with first and second acoustic passages in communication with a microphone retaining chamber and acoustic openings in an exterior surface. A microphone, disposed within the microphone retaining chamber, has a first acoustic port in an acoustic relationship with the first acoustic passage and a second acoustic port in an acoustic relationship with the second acoustic passage. A first and second set of electrical leads are disposed within the housing. A switching mechanism is secured to the housing and is positionable between a first position and a second position. In the first position, the first and second acoustic passages are in an acoustic receptive state and a first electric circuit is completed by connecting the first set of leads with a first connecting element. In the second position, either the first or the second acoustic passage is in an acoustic receptive state while the other acoustic passage is in an acoustic unreceptive state and a second electric circuit is completed by connecting the second set of leads with a second connecting element.

### BRIEF DESCRIPTION OF THE DRAWINGS

FIG. 1 is an exploded perspective view of the hearing aid construction of the present invention.

FIG. 2 is a perspective view of the housing of the hearing aid as viewed from above the housing.

FIG. 3 is a sectional view of a connector positioned adjacent to a set of leads which completes an electric circuit.

FIG. 4 is a sectional view of the hearing aid construction in a directional mode.

FIG. 5 is a schematic view of the switching mechanism in a first position.

FIG. 6 is a schematic view of the switching mechanism in a second position.

FIG. 7 is an exploded perspective view of a first alternative embodiment of the hearing aid construction of the present invention.

FIG. 8 is perspective view of the housing of the first alternative embodiment of the hearing aid construction of the present invention

FIG. 9 is a perspective view of a second alternative embodiment of the hearing aid construction of the present invention.

FIG. 10 is a partially exploded view of the second alternative embodiment of the hearing aid construction of the present invention as viewed from above.

FIG. 11 is an exploded perspective view of the second alternative embodiment of the hearing aid construction of the present invention as viewed from beneath the construction.

FIG. 12 is a top view of the second alternative embodiment of the hearing aid construction of the present invention.

FIG. 13 is a sectional view of the second alternative embodiment of the present invention along the section line 1-1 in FIG. 12.

FIG. 14 is a sectional view of the second alternative embodiment of the present invention along the section line 2-2 in FIG. 12.

FIG. 15 is a side view of the second alternative embodiment of the present invention.

FIG. 16 is a partial sectional view of the second alternative embodiment of the present invention along the section line 3-3 in FIG. 15.

### DETAILED DESCRIPTION

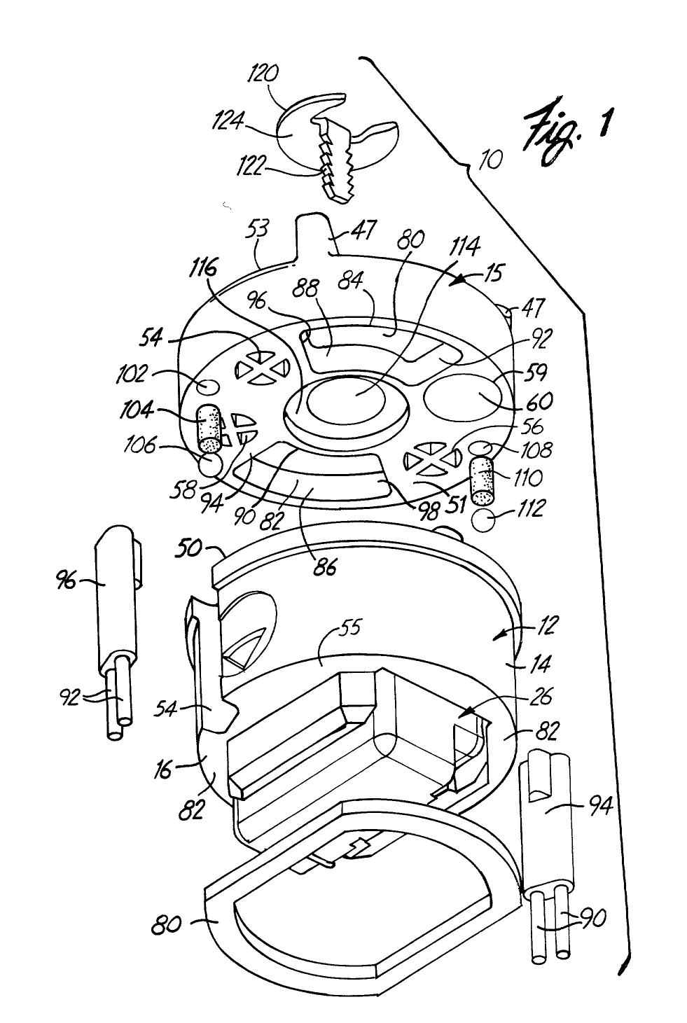

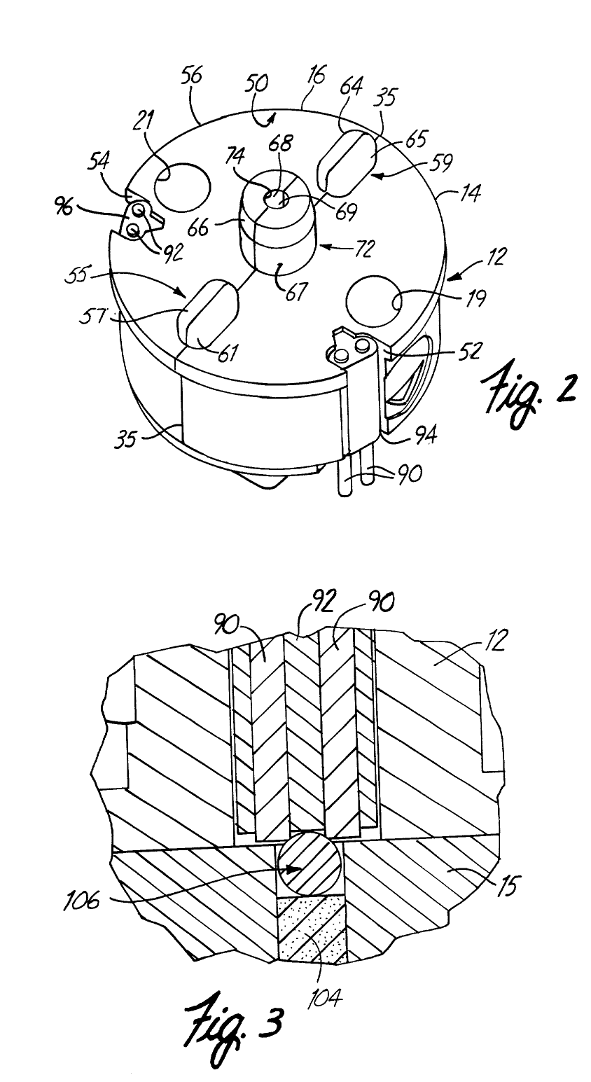

Referring to FIG. 1 the hearing aid construction of the present invention is generally indicated at 10. As illustrated in FIG. 1, the housing 12 preferably includes matching and substantially identical housing halves 14 and 16. The housing halves 14 and 16 are identical except for the location of a first lead retaining indention 52 and a second retaining indention 54 which are not symmetrically located within the first and second housing halves 14 and 16 as best illustrated in FIG. 2.

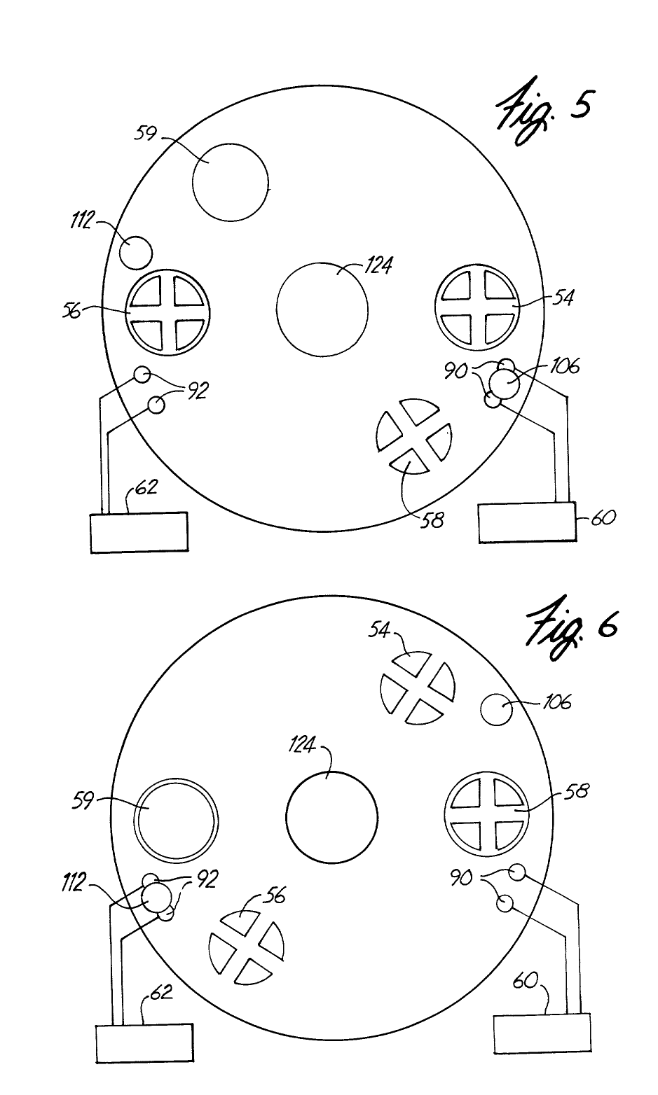

A switching mechanism 15 is attached to a second end 50 of the housing 12. The switching mechanism 15 includes both mechanical switching capabilities and electrical switching capabilities thereby allowing a single switching mechanism to perform multiple functions. In a hearing aid construction, it is advantageous to reduce the size of equipment, and reducing the number of switches allows the size of the hearing aid construction to be reduced. The switching mechanism 15 is positioned into a first position where a microphone 26 is in a directional mode and a first electric circuit 60 is completed while a second electric circuit is broken as illustrated in FIG. 5. The switching mechanism 15 is rotated into a second position wherein the microphone 26 is in an omni-directional mode and the second circuit is completed while the first electric circuit is broken as illustrated in FIG. 6.

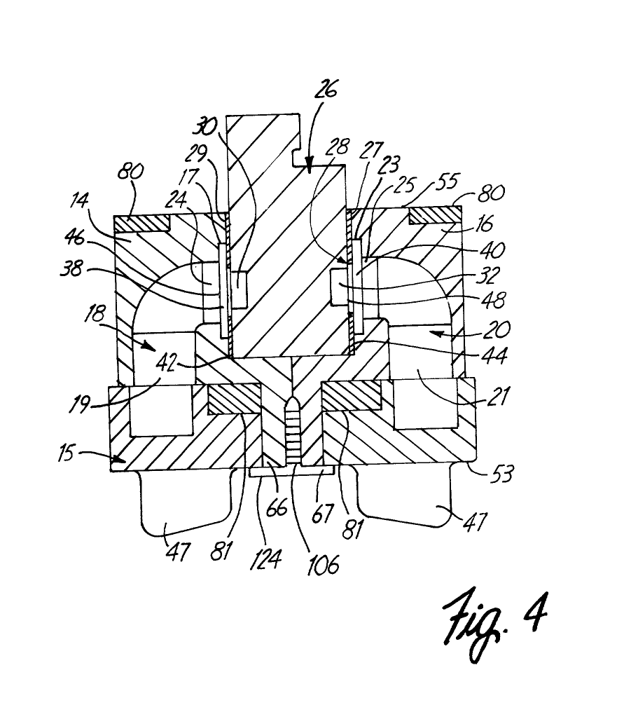

Referring to FIG. 4, each housing half 14 and 16 includes an acoustic passage 18 and 20. Each acoustic passage 18 and 20 extends from an exterior opening 19 and 21 to an interior opening 24 and 25 within a microphone retaining chamber 28 of the housing halves 14 and 16, all respectively.

The directional microphone 26 is positioned within the microphone retaining chamber 28 that is formed by the housing halves 14 and 16. The directional microphone 26 is of standard construction having a first acoustic port 30 and a second acoustic port 32 disposed on opposite sides of a diaphragm (not shown). The acoustic ports 30 and 32 are positioned to be in an acoustic relationship with the acoustic passages 18 and 20 through openings 24 and 25 of the housing halves 14 and 16, all respectively, when the microphone 26 is positioned within the chamber 28. The housing halves 14 and 16 may be joined together by any suitable method such as adhesive, ultrasonic welding or a snap fit of a pin in the first housing half being inserted into a mating hole in the second housing half and a pin in the second housing half being inserted into a mating hole in the first housing half.

Acoustic dampers 38 and 40 are positioned within recesses 17 and 23 proximate the openings 24 and 25, respectively, such that the acoustic dampers 38 and 40 completely cover the openings 24 and 25 without extending beyond a flat surface 29 and 27, all respectively, of the microphone retaining chamber 28. Alternatively, the dampers 38 and 40 can be positioned inside the microphone 26 or at the exterior openings 19 and 21 of the acoustic passages 18 and 20.

Damper seals 42 and 44 are disposed between the acoustic dampers 38 and 40 and the acoustic ports 30 and 32, as best illustrated in FIG. 4. Each damper seal 42 and 44 is positioned adjacent to and substantially covers the surface 29 and 27, respectfully, of the microphone retaining chamber 28. With the damper seals 42 and 44 positioned adjacent to the surfaces 29 and 27 of the microphone retaining chamber 28, an aperture 46 and 48 within the damper seals 42 or 44 is disposed about the interior acoustic openings 24 and 25, respectively. When the housing halves 24 and 16 are joined together, the damper seals 42 and 44 form a seal between the housing 12 and the microphone 26, while maintaining an acoustic relationship between the acoustic passages 18 and 20 and the acoustic ports 30 and 32 of the microphone 26.

The damper seals 42 and 44 are made of a compressable polymer such as a natural or synthetic rubber and are necessary to provide a tight acoustic seal. The damper seals 42 and 44 eliminate any leakage due to variation in construction of the housing halves 14 and 16 and the microphone 26 and dimensional variations that may result from snapping together the housing halves 14 and 16. The damper seals 42 and 44 along with the acoustic passages 18 and 20 being part of the housing 12 provide a very efficient acoustic path with virtually no leakage. The damper seals 42 and 44 provide a better acoustic seal than a standard O-ring seal because the damper seals 42 and 44 have more contact area between the housing 12 and the microphone 26 and thereby prevent sound from escaping from a gap between the housing 12 and the microphone 26.

Referring to FIG. 2, first tabs 57 and 61 and second tabs 64 and 65 extend from each of the interior surfaces 35 proximate a second end 50 of the housing halves 14 and 16. The first tabs 57 and 61 and the second tabs 64 and 65 are located proximate an outer edge 56 of the housing 12. Substantially centrally located along the interior surface 35 and extending from the second end 50 are first and second semicircular center portions 66 and 67, each having a groove 68 and 69 formed therein. When the housing halves 14 and 16 are joined such that the interior surfaces 35 are adjacent, the first tabs 57 and 61 cooperate to form a first stop 55. Similarly, the second tabs 64 and 65 cooperate to form a second stop 59. The semicircular portions 66 cooperate to form a member 72 having a cylindrical outer surface and an aperture 74 substantially centrally located within the cylindrical member 72. It will be appreciated that the exterior openings 19 and 21 of the acoustic passages 18 and 20 are equidistant from the cylindrical member 76 which becomes important when switching from an omni-directional to a directional mode of operation.

Because the damper seals 42 and 44 are compressed when the housing halves 14 and 16 are snap fit together, the damper seals 42 and 44 urge the housing halves 14 and 16 apart. If the housing halves 14 and 16 slightly separate, the acoustic seal between the microphone 26 and the surface of the microphone retaining chamber 28 will be compromised making the hearing aid 10 less effective.

Referring to FIGS. 1 and 4, a first retaining ring 80 is positioned about a shoulder 82 proximate a first end 55 of the housing 12 thereby preventing the housing halves 14 and 16 proximate the first end 55 from separating. Referring to FIG. 4, a second retaining ring 81 is positioned about the cylindrical member 76 proximate the second end 50, thereby preventing the housing halves 14 and 16 proximate the second end 50 from separating. With the first and second retaining rings 80 and 84 positioned about the housing 12 proximate the first and second ends 55 and 50, the housing halves 14 and 16 are secured into a position thereby ensuring an acoustic seal between the housing 12 and the microphone 26.

Referring to FIGS. 1 and 2, a first set of electrical leads 90 are attached to an exterior side surface of the first housing half 14. Preferably the first set of leads 90 are retained within a first molding 94 which cooperates with the first lead retaining indention 52 within the exterior surface having a complimentary configuration to the first molding 94 such that the first molding 94 is secured to the first housing half 14. The first set of leads 90 within the first molding 94 are located proximate the acoustic opening 19. The first set of leads 90 can be attached to any electrical circuit which may be helpful to the user such as an equalizer, an electric filter to reduce background noise or an attenuation circuit. This list of circuits is by way of example and is in no way meant to be limiting. Preferably the first set of leads 90 and the molding 94 are a simple pole switch.

Attached to the exterior surface of the second housing half 16 is a second set of electrical leads 92. The second set of leads 92 are contained within a second molding 96 having the same configuration as the first molding 94 containing the first set of leads 90. The second housing half 16 includes a second lead retaining indention 54 within the exterior surface of the housing half 16 wherein the second lead retaining indention 54 has a complimentary configuration to the second molding 96 such that the second molding 96 is secured to the second housing half 16. The second set of leads 92 are located proximate the second acoustic opening 21 the same distance away from the second acoustic opening 21 as the first set of leads 90 are located from the first acoustic opening 19. The first and second sets of leads 90 and 92 are offset from the center of the housing 12 and cannot be connected by a line passing through the center of the housing 12 as best illustrated in FIG. 2.

Referring to FIG. 1, the switching mechanism 15 preferably has a circular perimeter corresponding to the general circumference and diameter of the housing 12 and is preferably rotatably attached to the housing 12. The switching mechanism 15 includes acoustic switching ports 54, 56 and 58, and a port 59 plugged with an acoustic port seal 60. Attached to a second surface of the switching mechanism 15 are a plurality of gripping members 47 which allow the user to grip and manipulate the switching mechanism 15 as illustrated in FIGS. 1 and 4.

A first bore 102 is disposed between the acoustic ports 54 and 58. A first compressive element 104 is disposed within the first bore 102. A first connecting element 106 is position upon the first compressive element 104 such that the first connecting element 106 is partially disposed within the first bore 102 and partially extending therefrom. The compressive element 104 is preferably a compressive foam or a spring. The first connecting element 106 is preferably a ball or sphere constructed of an electrically conductive material such as copper or silver.

A second bore 108 is disposed between the acoustic ports 56 and 59. A second compressive element 110 is disposed within the second bore 108. A second connecting element 112 is positioned upon the second compressive element 110 such that the second connecting element 112 is partially disposed within the second bore 108 and partially extends therefrom. The compressive element 110 is preferably a compressive foam or a spring. The second connecting element 112 is preferably a ball or sphere constructed of an electrically conductive material such as copper or silver. The first connecting element 106 and the second connecting element 112 are positioned opposite each other such that a line passing through a center of the switching mechanism 15 intersects the connecting elements 106 and 112.

A first indention 80 and a second indention 82 are disposed within a first surface 51 of the switching mechanism 15 where the second indention 82 is opposite the first indention 80. The first and second indentions 80 and 82 have substantially similar geometries wherein each indention has arcuate first surfaces 84 and 86 and second surfaces 88 and 90, respectively, wherein the first arcuate surfaces 84 and 86 are longer than the second arcuate surfaces 88 and 90. The first and second arcuate surfaces 84, 86, 88, 90 are connected by side surfaces wherein radial lines define first side surfaces 92 and 94 and second side surfaces 96 and 98.

Substantially centrally located within the switching mechanism 15 is a through hole 114. A shoulder 116 centrally located and extending from the first surface 57 accommodates the second retaining ring 81. A diameter of the through hole 114 at a second surface 53 accommodates the cylindrical member 72.

The switching mechanism 15 is positioned about the housing 12 such that the cylindrical member 72 is substantially even with the second surface 53 of the switching mechanism 15. Additionally, the first stop 55 is positioned within the first indention 80 and the second stop 59 is positioned within the second indention 82. A pin 120 secures the switching mechanism 15 to the housing 12 by engaging the aperture 74 within the cylindrical member 72. A plurality of ridges 122 extending from the shaft of a pin 120 engage the aperture 74 which secures the pin 120 within the aperture 74. A head 124 of the pin 120 has a diameter greater than the diameter of the through hole 114 within the second surface 53 of the switching mechanism 15. The head 124 prevents the switching mechanism 15 from detaching from the housing 12, thereby rotatably securing the switching mechanism 15 to the housing 12. The first and second compressible elements 104 and 110 are compressed such that the first and second connecting elements 106 and 112 are disposed within the first and second bores 102 and 108 thereby positioning the first surface 51 of the switching mechanism 15 adjacent to the housing 12 when the switching mechanism 15 is rotatably secured to the housing 12.

In operation, the hearing aid 10 is positioned into a first position corresponding to a directional mode and also connecting the first set of leads 90 as illustrated in FIG. 5. The switching mechanism 15 is manipulated into the first position by rotating the switching mechanism 15 until the first stop 55 contacts the first side surface 92 of the first indention 80 and at substantially the same time, the second stop 59 contacts the first side surface 94 of the second indention 82. With the first and second stops 62 and 59 contacting the first side surfaces 92 and 94 of the first and second indentions 80 and 82, the first acoustic port 54 aligns with the acoustic passage 18 in the first housing half 14 and the second acoustic port 56 aligns with the acoustic passage 20 in the second housing half 16. With the acoustic passages 18 and 20 able to pass sound therethrough, the first and second acoustic ports 30 and 32 of the microphone 26 are in an acoustically receptive state thereby positioning the hearing aid 10 into a directional mode.

Besides placing the microphone 26 into a directional mode, the first connector 106 connects the first set of leads 90 and thereby completes a first electrical circuit 60 allowing the hearing aid construction 10 to perform an additional operation. Referring to FIG. 3 the first electric circuit 60 is completed by a surface of the connector 106 being forced into contact with the ends of the first set of leads 90, the force being applied to the connector 106 by the compressible element 104. Referring to FIG. 5, the second connector 112 is a distance from the second set of leads 92 and thereby prevents the hearing aid construction 10 from performing an operation connected to the second set of leads 92.

The user of the hearing aid construction 10 can place the hearing aid construction 10 into a second position or an omni-directional mode and also complete the second electric circuit 62 as illustrated in FIG. 6. To manipulate the hearing aid construction 10 into the second position, the switching mechanism 15 is rotated until the first stop 55 contacts the second side surface 96 of the first indention 80, and the second stop 59 contacts the second side surface 98 of the second indention 82. With the first and second stops 62 and 59 contacting the second side surfaces 96 and 98 of the first and second indentions 80 and 82, the third acoustic port 58 is aligned with the acoustic passage 18 in the first housing half 14. The acoustic passage 20 in the second housing half 16 is sealed off by the acoustic port seal 60 within the port 59. With the acoustic passage 20 in the second housing half 16 sealed, the acoustic port 32 in the microphone 26 which is in communication with the acoustic passage 20 in the second housing half 16 is in an acoustically unreceptive state.

Besides placing the microphone 26 in an omni-directional mode, the second connecting element 112 connects the second set of leads 92 and thereby completes a second electrical circuit 62 allowing the hearing aid construction 10 to perform a function associated with the second electrical circuit 62. Additionally, the first connector 106 is a distance from the first set of leads 90 and thereby prevents the hearing aid from performing the operation associated with the first electrical circuit 60.

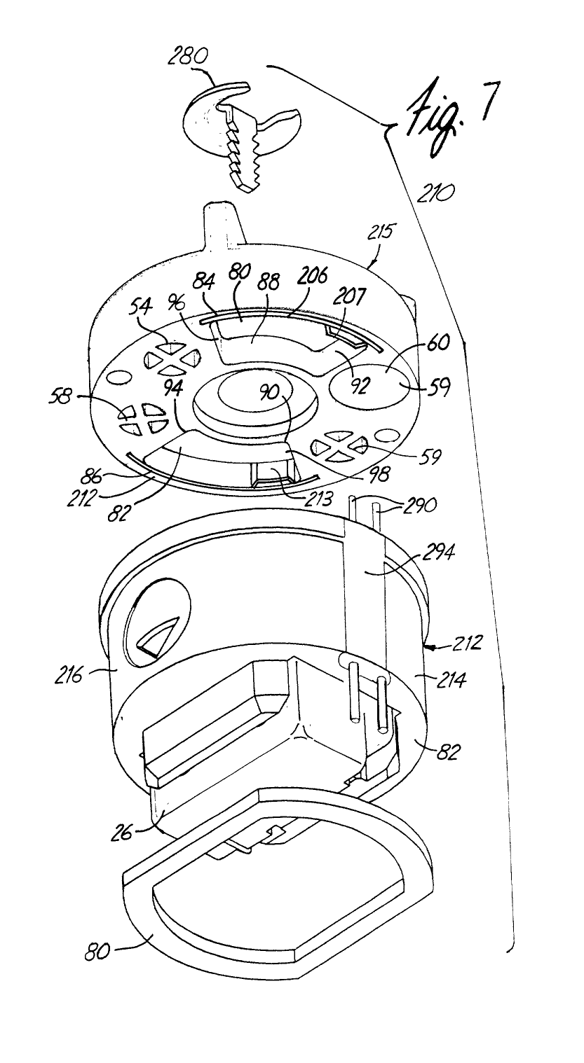

A first alternative embodiment 210 of the present invention is illustrated in FIGS. 7 and 8. The hearing aid construction 210 is similar to the embodiment 10 and operates in the same manner. Components within the alternative embodiment 210 which are the same as the components in the embodiment 10 will be given the same reference numbers.

The differences between the embodiment 210 and the embodiment 10 include securing the first and second sets of leads 290 and 292 to an external surface of the housing 212 at the mating surfaces 235 of the housing halves 214 and 216 when the housing halves 214 and 216 are joined together. The first and second sets of leads 290 and 292 are opposite or 180 degrees away from each other. Additionally, the first and second leads 290 and 294 extend beyond a surface 250 of the housing 212.

The connectors 206 and 212 are secured within the first and second indentions 80 and 82 adjacent to a first arcuate surface 84 and 86, respectively. The connectors 206 and 212 are constructed of a flat metal material that conforms to the first arcuate surfaces 84 and 86. The first connector 206 includes a first contact portion 207 positioned away from the first arcuate surface 84 proximate a first surface 92 of the indention 80. The second connector 212 includes a second contact portion 213 positioned away from the first arcuate surface 86 proximate the second wall 98 of the indention 82. The distance between the leads 290 and 292 must be narrower than the width of the first and second stops 55 and 59 so that the leads 290 and 292 do not interfere with the switching mechanism 215 being positioned into either the first or second position.

The operation of the embodiment 210 is similar to the operation of the embodiment 10. The embodiment 210 is placed into a first position when the first surfaces 92 and 94 of the first and second indentions 80 and 82 are adjacent to the first and second stops 55 and 59. With the first and second stops 55 and 59 contacting the first side surfaces 92 and 94 of the first and second indentions 80 and 82, the first acoustic port 54 aligns with the acoustic passage 18 in the first housing half 214 and the second acoustic port 56 aligns with the acoustic passage 20 in the second housing half 216. With the acoustic passages 18 and 20 able to pass sound therethrough, the first and second acoustic ports 30 and 32 of the microphone 26 are in an acoustically receptive state thereby positioning the hearing aid construction 210 into a directional mode.

Besides placing the microphone 26 into a directional mode, the first connector 206 connects the first set of leads 290 and thereby completes a first electrical circuit 60 allowing the hearing aid construction 210 to perform an additional operation. The first electric circuit 60 is completed by the first contact portion 207 of the first connector 206 contacting the first set of leads 290 which extend into the first indention 80 similar to the first stop 55. Additionally, the second contact portion 213 of second connector 212 extending from the first arcuate surface 86 is proximate the second side wall 98 while the second set of leads 292 is proximate the first wall 94, therefore the second electrical circuit 62 is broken which prevents the hearing aid construction 210 from performing an operation associated with the second electric circuit 62.

The hearing aid construction 210 is manipulated into a second position by rotating the switching mechanism 15 about the pin 280 until the first stop 55 contacts the second side surface 92 of the first indention 80 and the second stop 59 contacts the second side surface 98 of the second indention 82. With the first and second stops 55 and 59 contacting the second side surfaces 96 and 98 of the first and second indentions 80 and 82, the third acoustic port 58 is aligned with the acoustic passage 18 in the first housing half 214. The acoustic passage 20 in the second housing half 216 is acoustically blocked by the acoustic port seal 60 within the port 59. With the acoustic passage 20 in the second housing half 216 sealed, the acoustic port 32 in the microphone 26 which is in communication with the acoustic passage 20 in the second housing half 216 is in an acoustically unreceptive state.

Besides placing the microphone into an omni-directional mode, the second connector 212 connects the second set of leads 292 and thereby completes the second electrical circuit 62 allowing the hearing aid construction 210 to perform an additional operation. The second electric circuit 62 is completed by the second contact portion 213 of the second connector 212 contacting the second set of leads 292 wherein the second set of leads 292 extend into the second indention 82 similar to the second stop 59. Additionally, the first contact portion 207 of first connector 206 extending from the first arcuate surface 84 is proximate the first side surface 92 while the first set of leads 290 is proximate the second side surface 96, thereby breaking the first electrical circuit 60 which prevents the hearing aid construction 210 from performing an operation associated with the first electric circuit 60.

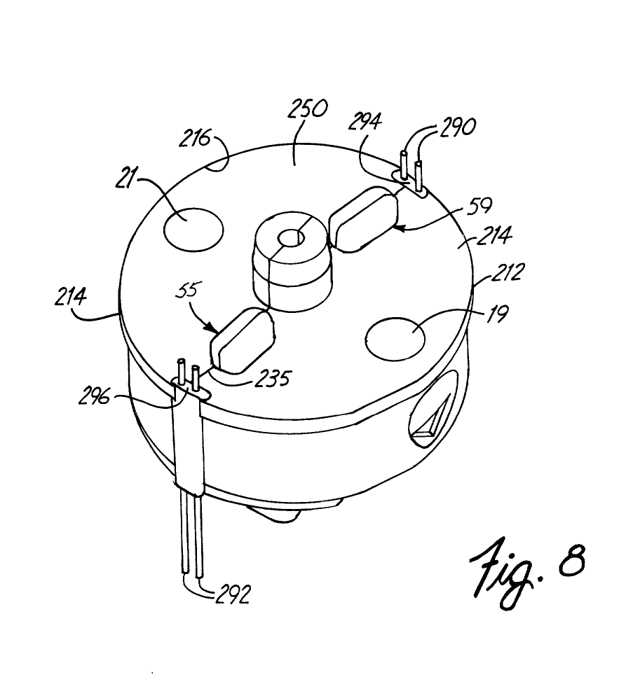

In a second alternative embodiment, the hearing aid construction 310 includes the switching mechanism 315 being sidably attached to the housing 312. As illustrated in FIGS. 9-11, the housing 312 contains a microphone 326 disposed between matching and identical housing halves 314 and 316. A first set of leads 390 extend from a first side of the construction 310 and a second set of leads 394 extend from a second side of the construction 310. The housing halves 314 and 316, the first and second leads 390 and 394, the microphone 326 and the switching mechanism 315 are retained into a position by a first retaining clip 350 and a second retaining clip 360.

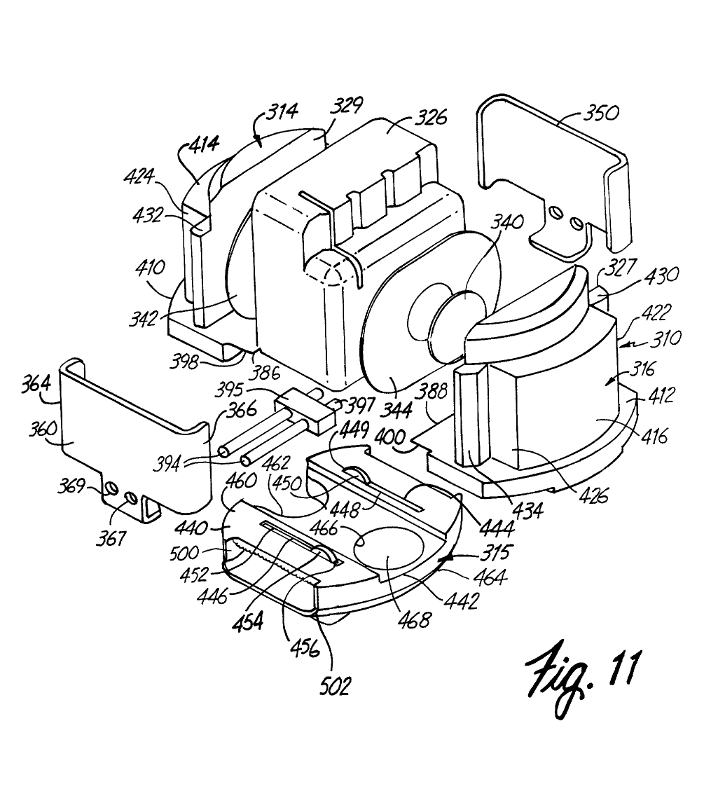

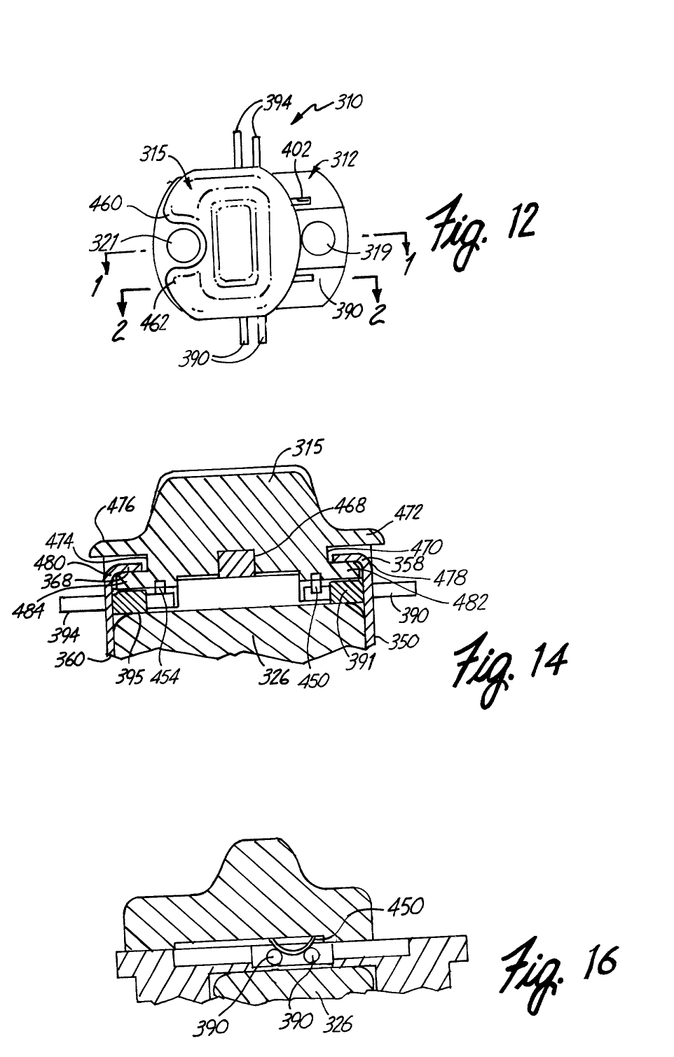

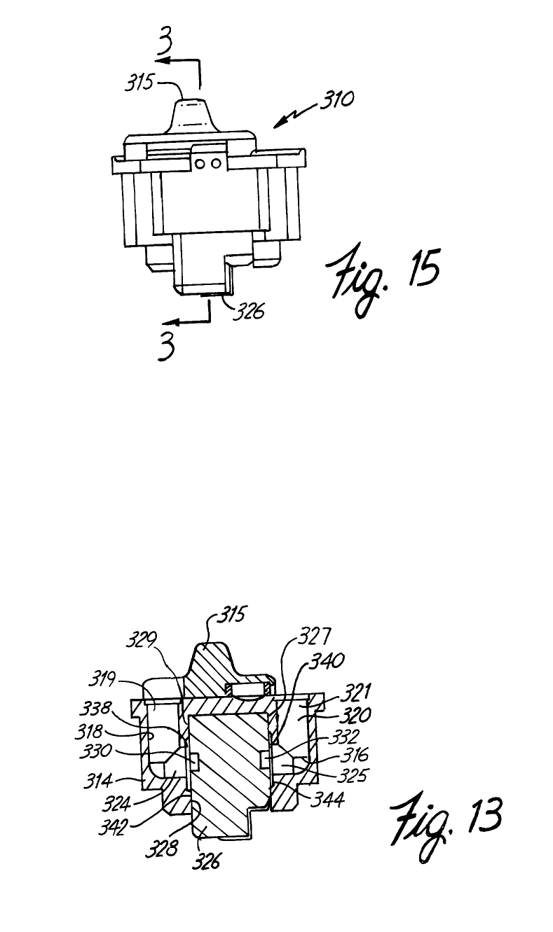

Referring to FIGS. 12 and 13, each housing half 314 and 316 includes an acoustic passage 318 and 320 extending from an exterior opening 319 and 321 to an interior opening 324 and 325 within a microphone retaining chamber 328 of the housing halves 314 and 316, all respectively. The directional microphone 326 is positioned within the microphone retaining chamber 328 that is formed by the housing halves 314 and 316. The directional microphone 326 is of standard construction having a first acoustic port 330 and a second acoustic port 332 disposed on opposite sides of a diaphragm (not shown). The acoustic ports 330 and 332 are positioned to be in an acoustic relationship with the acoustic passages 318 and 320 through the interior openings 324 and 325 of the housing halves 314 and 316, all respectively, when the microphone 326 is positioned within the chamber 328.

Referring to FIGS. 11 and 13, acoustic dampers 338 and 340 are positioned within recesses proximate the interior openings 324 and 325, respectively, such that the acoustic dampers 338 and 340 completely cover the openings 324 and 325 without extending beyond a surface 329 and 327 of the microphone retaining chamber 328. Alternatively, the dampers 338 and 340 can be positioned inside the microphone or at the exterior openings of the acoustic passages.

Damper seals 342 and 344 are disposed between the acoustic dampers 338 and 340 and the acoustic ports 330 and 332. Each damper seal 342 and 344 is positioned adjacent to and substantially covers the surfaces 329 and 327 of the microphone retaining chamber 328. With the damper seals 342 and 344 positioned adjacent to the surfaces 329 and 327 of the microphone retaining chamber 328, an aperture within each damper seal 342 and 344 disposes about the interior acoustic opening 324 and 325 within each surface 329 and 327, respectively. When the housing halves 314 and 316 are joined together, the damper seals 342 and 344 form a seal between the housing 312 and the microphone 326, while maintaining an acoustic relationship between the acoustic passages 318 and 320 and the acoustic ports 330 and 332 of the microphone 326.

The damper seals 342 and 344 are made of a compressable polymer such as a natural or synthetic rubber and are necessary to provide a tight acoustic seal. The damper seals 342 and 344 eliminate any leakage due to variation in construction of the housing halves 314 and 316 and the microphone 326 and dimensional variations that may result from clipping together the housing halves 314 and 316. The damper seals 342 and 344 along with the acoustic passages 318 and 320 being part of the housing 312 provide a very efficient acoustic path with virtually no leakage. The damper seals 342 and 344 provide a better acoustic seal than a standard O-ring seal because the damper seals 342 and 344 have more contact area between the housing 312 and the microphone 326 and thereby prevent sound from escaping from a gap between the housing 312 and the microphone 326.

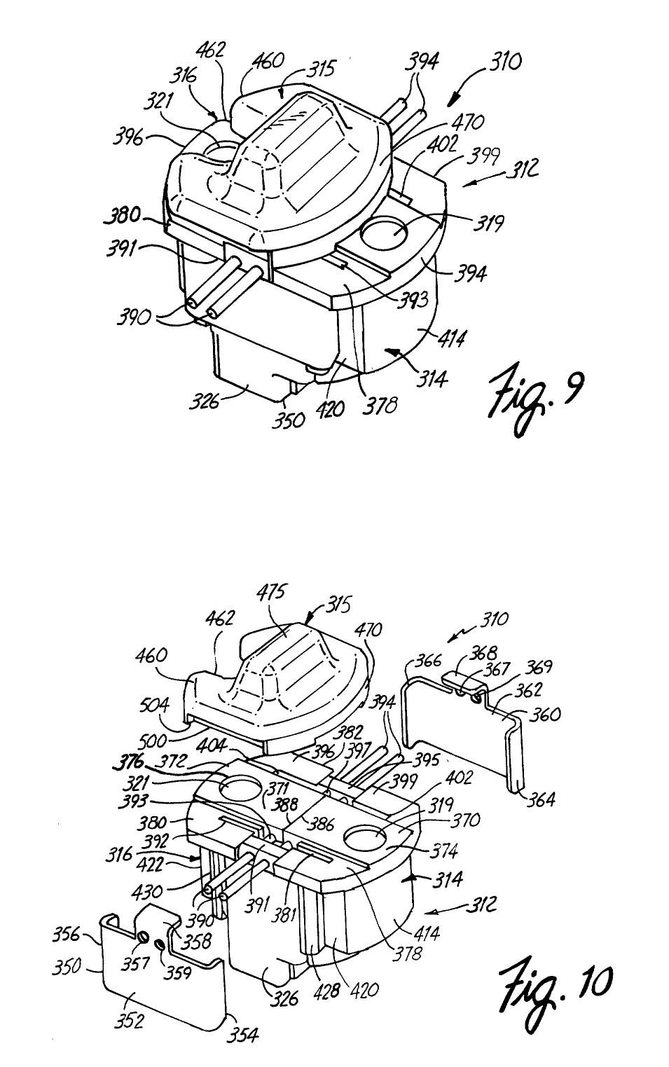

Referring to FIG. 10, each housing half 314 and 316 includes a raised portion 370 and 372 substantially centrally located within a top surface 374 and 376 and extending along a length thereof. Within the raised portions 370 and 372 of each housing half 314 and 316 are the exterior openings 319 and 321 of the acoustic passages 318 and 320. A first portion 378 and 380 extending from a first side of the raised portion 370 and 372 includes a first thin portion (not shown), proximate contacting ends 386 and 388 of the housing halves 314 and 316 positioned below the first set of leads 381. Referring to FIG. 10, within the first side portions 378 and 380 are first grooves 381 and 392, each extending from an end of the first thin portions (not shown) wherein the grooves 390 and 392 are proximate and parallel to the raised portions 370 and 372, all respectively.

Second side portions 394 and 396 extend from second sides of the raised portions 370 and 372. The second side portions 394 and 396 also include second thin portions 398 and 400 as illustrated in FIG. 11, proximate the contacting ends 386 and 388, each having the same dimensions as the first thin portions (not shown) of the first side portions 378 and 380. Referring back to FIG. 10, second grooves 402 and 404, extending from an end of the second thin portions 398 and 400, are proximate and parallel to the raised portions 370 and 372, respectively.

The contacting ends 386 and 388 of the housing halves 314 and 316 are placed adjacent each other such that the raised portions 370 and 372 align to form one continuous raised portion 371 along the length of the housing 312. The first side portions 378 and 380 align to form a first recess for retaining the first set of leads 390. Similarly, the second side portions 394 and 396 align to form a second recess for retaining the second set of leads 394. Additionally, the first grooves 390 and 392 and the second grooves 402 and 404 are aligned but separated by the first and second recesses, respectively.

Extending from second surfaces 410 and 412 of the top portion of the first and second housing halves 314 and 316 are first and second microphone retaining portions 414 and 416 as best illustrated in FIG. 11. The first and second acoustic passages 318 and 320 are within the first and second microphone retaining portions 414 and 416 wherein the interior openings 324 and 325 of the first and second acoustic passages 318 and 320 are located within the first and second flat surfaces 329 and 327 of the first and second microphone retaining portions 414 and 416, respectively. Extending outwardly from first side surfaces 420 and 422 and second side surfaces 424 and 426 of the microphone retaining portions 414 and 416 are first tabs 428 and 430 and second tabs 432 and 434 wherein a surface of the first tabs 428 and 430 and the second tabs 432 and 434 are substantially even with the flat surfaces 429 and 427.

The first set of leads 390 are positioned within the first recess created by the first side portions 378 and 380 of the first and second housing halves 314 and 316. The first set of leads 390 proximate a first end are retained within a first molding 391. The molding 391 is constructed of a nonconductive material so that the molding 391 does not connect the first set of leads 390 and thereby completing a first electric circuit. The molding 391 is of a configuration such that the molding 391 is positioned and retained within the first recess and is supported by the first thin portions (not shown). Extending inwardly from the molding 391 are ends 393 of the first set of leads 390. The ends 393 of the first set of leads 390 are adjacent to a side of the raised portion 371.

Similarly, a second set of leads 394 are positioned within a second recess and supported by the second thin portions 398 and 400 within the second side portions 394 and 396 of the first and second housing halves 314 and 316. The second set of leads 394, proximate a first end 397, are retained within a second molding 395. The molding 395 is constructed of a nonconductive material such the molding 395 does not connect the second set of leads 394 and thereby complete the second circuit. The molding 395 is of a configuration such that the molding 395 is positioned and retained within the second recess created by the thin portions 398 and 400. Extending inwardly from the molding 395 are the first set of lead ends 397 of the second set of leads 394. The ends 397 of the second set of leads 394 are positioned adjacent to a second side surface of the raised portion 371.

The switching mechanism 315, having a width substantially the same as the width of the housing 312, slidably engages the housing 312. Referring to FIG. 11, the switching mechanism 315 includes a first surface 440 which is complimentary to the top surfaces 374 and 376 of the housing 312. The switching mechanism 315 includes a recess 442 which disposes about the raised portion 371 of the housing 312. Within the first surface 440 is a first channel 444 and a second channel 446 which align with the first grooves 381 and 392 and the second grooves 402 and 404 within the housing, respectively. Proximate a first end 460 of the switching mechanism 315 is a curved indention 462 and proximate a second end 464 of the switching mechanism 315 is a recess 466 having an acoustic port seal 468 disposed therein.

The first channel 444 accommodates a first connector 448 wherein the first connector 448 is made of an electrically conductive material. Proximate a first end 449 of the connector 448 is a curved portion 450 extending beyond the first surface 440 of the switching mechanism 315. With the switching mechanism 315 engaging the housing 312, the curved portion 450 extends into the first set of grooves 381 and 392 in the housing 312 a distance which allows the curved portion 450 to contact the first set of leads 390 between the molding 391 and the raised portion 371 when the curved portion 450 is positioned between the first set of leads 390, thereby completing a first electric circuit as illustrated in FIG. 16.

The second channel 446 accommodates a second connector 452 wherein the second connector 452 is of the same configuration as the first connector 448 and is made of an electrically conductive material. The second connector 452 is positioned within the second channel 446 opposite the position of the first connector 448 in the first channel 444. Proximate a first end 456 of the second connector 452 is a curved portion 454 extending beyond the first surface 440 of the switching mechanism 315. With the switching mechanism 315 engaging the housing 312, the curved portion 454 extends into the second set of grooves 402 and 404 in the housing 312 a distance which allows the curved portion 454 to contact the second set of leads 394 when the curved portion 454 is positioned between the second set of leads 394, thereby completing a second electric circuit.

The configuration of the first and second connectors 448 and 452 within the switching mechanism 315 and the position of the first and second sets of leads 390 and 394 within the housing 312 prevent the first and second electric circuits from being completed at the same time. As illustrated in FIG. 14, when the first curved portion 450 contacts the first set of leads 390 and thereby completing the first electric circuit, the second curved portion 454 is a distance from the second set of leads 394, thereby breaking the second electric circuit. Similarly, when the second curved portion 454 contacts the second set of leads 394, thereby completing the second electric circuit, the first curved portion 450 is a distance from the first set of leads 390, thereby breaking the first electric circuit.

With the microphone 326, the first set of leads 390 and the second set of leads 394 positioned within the housing 312 and the switching mechanism 315 positioned on the housing 312, the construction 310 is fixed into a position with the first and second clips 350 and 360 being of identical configuration. The first and second clips 350 and 360 include main portions 352 and 362 each having first side tabs 354 and 364 proximate a first end and second side tabs 356 and 366 proximate the second end and switch retaining members 358 and 368 extending from a top surface.

Referring to FIG. 14, the switching mechanism 315 includes a first groove 470 within a first side surface 472 and a second groove 474 within a second side surface 476. The first side surface 472 of the switching mechanism 315 is retained on the housing 312 by the switch retaining member 358 extending inwardly from the first clip 350. The second side surface 476 is retained on the housing 312 by the second switch retaining member 368. The first and second moldings 391 and 395 are retained in position by an extension 482 and 484 disposed above the moldings wherein the extensions 482 and 484 define a bottom surface of the first and second grooves 472 and 474.

Referring to FIGS. 10, The first clip 350 includes first apertures 357 and 359 within the main portion 352 which accommodate the first set of leads 390 such that the first set of leads 390 pass therethrough. The first clip 350 is preferably constructed from a nonconductive material thereby preventing the first clip 350 from completing the first electric circuit.

The switch retaining member 358 extends from the top end proximate the first and second apertures 357 and 359. Referring to FIG. 14, the switch retaining member 358 extends into a first groove 470 within a first side 472 of the switching mechanism 315, thereby securing the first side 472 of the switching member 315 to the housing 312. Additionally, the switch retaining member 358 covers a side of the first recess and thereby prevents the first set of leads 390 and the molding 391 from being displaced from the side of the housing.

With the first set of leads 390 positioned through the first and second apertures 357 and 359 and the switch retaining mechanism 358 disposed within the first groove 470 in the first side surface 472 of the switching mechanism 315, the main portion 352 is rotated toward the microphone 326. As the main portion 352 is rotated toward the microphone 326, the first and second side tabs 354 and 356 engage the first tabs 428 and 430 extending from the first and second housing halves 314 and 316. respectively. The engagement of the first and second side tabs 354 and 356 of the first clip 350 with the first tabs 428 and 430 of the housing halves 314 and 316 urges the first and second housing halves 314 and 316 together and retains the microphone 326 between the housing halves 314 and 316.

The first clip 350 is positioned onto the housing 312 until an edge of the first and second side tabs 354 and 356 are adjacent to flat surfaces 420 and 422 of the microphone retaining portions 414 and 416, respectively. When the edges of the first and second side tabs 354 and 356 are adjacent to the flat surfaces 420 and 422 of the microphone retaining portions 414 and 416, the first clip 350 is securely attached to the housing 312 and retains a first side of the housing halves 314 and 316 and the microphone 326 into a selected position.

The second clip 360 is positioned onto the construction 310 in an identical fashion as the first clip 350. The second clip 360 has an identical construction as the first clip 350. The second clip includes first and second apertures 367 and 369 within the main portion 362 which accommodate the second set of leads 394 such that the second set of leads 394 pass therethrough. The second clip 360 is preferably constructed from a nonconductive material thereby preventing the second clip 360 from completing the second electric circuit.

The switch retaining member 368 extends from the top end proximate the first and second apertures 367 and 369. Referring to FIG. 14, the switch retaining member 368 extends into the second groove 474 within the second side 476 of the switching member 315, thereby securing the second side 476 of the switching member 315 to the housing 312.

With the second set of leads 394 positioned through the first and second apertures 367 and 369 and the switch retaining member 368 disposed within the second groove 474 in the second side surface 476 of the switching member 315, the main portion 362 of the second clip 360 is rotated toward the microphone 326. As the main portion 362 is rotated toward the microphone 326, the first and second side tabs 364 and 366 engage the second tabs 432 and 434 extending from the first and second housing halves 314 and 316. The engagement of the first and second side tabs 364 and 366 of the second clip 360 with the second tabs 432 and 434 of the housing halves 314 and 316 urges the first and second housing halves 314 and 316 together thereby retaining the microphone 326 between the housing halves 314 and 316.

The second clip 360 is positioned onto the housing 312 until an edge of the first and second side tabs 364 and 366 are adjacent to second flat surfaces 424 and 426 of the microphone retaining portions 414 and 416. When the edges of the first and second side tabs 364 and 366 are adjacent to the second flat surfaces 424 and 426 of the microphone retaining portions 414 and 416, the second clip 360 is securely attached to the housing 312 and retains a second side of the housing halves 314 and 316 and the microphone 326 into a selected position.

With the switching mechanism 315 slidably retained to the housing 12, the hearing aid construction 310 is positioned into a first position when a first end 500 of the first and second grooves 470 and 472 are adjacent to the switch retaining members 358 and 368. With the switching mechanism 315 in the first position, the second end 470 of the switching mechanism 315 is positioned between the first acoustic port 319 and the second acoustic port 321 leaving the first acoustic passage 318 open. With the first acoustic port 319 open, the first acoustic port 330 of the microphone 326 is in an acoustically receptive state. Additionally, the curved indention 462 is disposed about the second acoustic opening 321. With the second acoustic opening 321 exposed, the second acoustic port 332 in the microphone 326 is in an acoustic receptive state. Therefore, the microphone 326 is in a directional mode when the switching mechanism 315 is positioned into the first position. Additionally, besides positioning the microphone 326 into a directional mode, the curved portion 454 of the second connector 452 connects the second set of leads 394 and thereby completes the second circuit.

The hearing aid construction 310 is positioned into a second position by applying a force to a gripping member 475, an integral component of the switching mechanism 315, and sliding the switching member 315 about the housing 312 such that the second ends 502 of the grooves 472 and 474 is adjacent to the switch retaining members 358 and 368. With the hearing aid construction 310 in the second position, the second end 460 is between the first acoustic opening 319 and the second acoustic opening 321 and therefore the switching mechanism 315 does not interfere with the second acoustic opening 321 and therefore places the second acoustic port 332 in the microphone 326 into an acoustic receptive state. The first acoustic opening 319 is sealed by the acoustic port seal 468 disposed within the recess 466 in the switching mechanism 315 and therefore places the first acoustic port 330 into an acoustic nonreceptive state. Therefore, the microphone 326 is in an omni-directional mode when the switching mechanism 315 is in the second position.

Additionally when the switching mechanism 315 is in the second position, the curved portion 450 of the first connector 448 is positioned between the first set of leads 390, thereby completing the first electric circuit. The curved portion 454 of the second connector 452 is positioned away from the second set of leads 394 and thereby breaks the second circuit. Therefore when the switching mechanism 315 is in the second position, the microphone 326 is in an omni-directional mode, the first electric circuit is complete and the second electric circuit is broken.

Although the present invention has been described with reference to preferred embodiments, workers skilled in the art will recognize that changes may be made in form and detail without departing from the spirit and scope of the invention.

1. A microphone construction for use in a hearing aid, the construction comprising:
a housing having first and second acoustic passages communicating with a microphone retaining chamber, each acoustic passage extending through the housing to an exterior surface thereof;
a first set of leads disposed within the housing;
a second set of leads disposed within the housing;
a microphone disposed within the microphone retaining chamber and having first and second acoustic ports in an acoustic relationship with the first and second acoustic passages, respectively; and
a switching mechanism comprising first and second connecting elements wherein the switching mechanism is operably secured to the housing and positionable between a first position positioning the first and second acoustic passages in an acoustic receptive state and completing a first electric circuit by connecting the first set of leads with the first connecting element and breaking a second electric circuit by disconnecting the second set of leads from the second connecting element and a second position placing either the first or the second acoustic passage in an acoustic receptive state while blocking the other acoustic passage and completing the second electric circuit by connecting the second set of leads with the second connecting element while breaking the first electric circuit by disconnecting the first set of leads from the first connecting element.

2. The construction of claim 1 wherein the switching mechanism is slidably secured to the housing.

3. The construction of claim 2 wherein the switching mechanism further comprises an arcuate recess proximate a first end and a recess proximate a second end having an acoustic seal disposed therein.

4. The construction of claim 3 wherein the first and second connecting elements comprise:
flat portions having a first end and a second end; and
a curved portion proximate the first end wherein the curved portion extends into the housing from the switching mechanism.

5. The construction of claim 1 wherein the switching mechanism is rotatably secured to the housing.

6. The construction of claim 5 wherein the first and second connectors each comprises:
a ball constructed of an electrically conductive material; and
a compressive element positioned within a bore in the switching mechanism wherein the ball is disposed on the compressive element and wherein the compressive element urges the ball toward the housing.

7. The construction of claim 6 wherein the compressive element is a compressible foam.

8. The construction of claim 6 wherein the switching mechanism further comprises first, second and third acoustic ports and a blank port, wherein when the switching mechanism is positioned in the first position, the first and second acoustic ports are in an acoustic relationship with the first and second acoustic passages within the housing and the first connector completes the first electric circuit by connecting the first set of leads and wherein the second connector is displaced from the second set of leads thereby breaking the second electric circuit and wherein when the switching mechanism is positioned in the second position, the third acoustic port is in an acoustic relationship with the first acoustic passage and the blank port seals the second acoustic passage and the second connector completes the second electric circuit by connecting the second set of leads and the first electric circuit is broken with the first connector displaced from the first set of leads.

9. The construction of claim 8 wherein the switching mechanism further comprises a first interior cavity and a second interior cavity.

10. The construction of claim 9 wherein the first connecting element comprises a first flexible metal member disposed within the first interior cavity within the switching mechanism wherein the first flexible metal member includes a first portion extending into the first interior cavity.

11. The construction of claim 10 wherein the second connecting element comprises a flexible metal member disposed within the second interior cavity within the switching mechanism the second flexible metal member having a second portion extending into the second interior cavity.

12. The construction of claim 11 wherein an end of the first and second sets of leads extend beyond a surface of the housing and into the first and second cavities respectively, such that when the switching mechanism is placed into the first position the first portion of the first connector connects the first set of leads while the second portion of the second connector is displaced from the second set of leads and wherein when the switching mechanism is positioned into the second position the second portion of the second connector connects the second set of leads while the first portion of the first connector is displaced from the first set of leads.

13. A method of reducing the number of switches within a miniature hearing aid, the method comprising:
providing a housing having a first acoustic passage and a second acoustic passage;
providing a microphone disposed within the housing, the microphone having a first acoustic port in communication with the first acoustic passage and a second acoustic port in communication with the second acoustic passage
providing a first set of leads positioned within the housing;
providing a second set of leads positioned within the housing;
providing a switching mechanism comprising first and second connecting elements; and
operably connecting the switching mechanism to the housing, the switching mechanism positionable into a first position wherein the first and second acoustic ports are in an acoustically receptive state and a first connecting element disposed within the switching mechanism connects the first set of leads and completes a first electric circuit while positioning a second connecting element apart from the second set of leads thereby breaking a second circuit and wherein the switching mechanism is positionable into a second position wherein either the first or second acoustic ports is in an acoustically receptive state and the other acoustic port is in an acoustically unreceptive state and the second connecting element completes the second electric circuit by connecting the second set of leads while positioning the first connecting element apart from the first set of leads thereby breaking the first electric circuit.

14. The method of claim 13 and further comprising rotatably securing the switching mechanism to the housing such that the switching mechanism rotates between the first position and the second position.

15. The method of claim 14 and further comprising providing the switching mechanism with first, second and third acoustic ports and a port plugged with an acoustic port seal such that first and second acoustic ports are in an acoustic relationship with the acoustic passages of the housing when the switching mechanism is in the first position, and the third acoustic port is in an acoustic relationship with the first acoustic passage and the port plugged with the acoustic port seal acoustically seals the second acoustic passage when the switching mechanism is in the second position.

16. The method of claim 15 and further comprising providing an end of the first and second sets of leads extending beyond a surface of the housing and into a first and a second cavity within the switching mechanism respectively, such that when the switching mechanism is placed in the first position a first portion of the first connector connects the first set of leads while a second portion of the second connector is apart from the second set of leads and wherein when the switching mechanism is positioned into the second position the second portion of the second connector connects the second set of leads while the first portion of the first connector is apart from the first set of leads.

17. The method of claim 13 and further comprising slidably connecting the switching mechanism to the housing wherein the switching mechanism is slidable between the first position and the second position.

18. The method of claim 17 and further comprising providing the first connector with a first curved portion which completes the first circuit by contacting the first set of leads and providing the second connector with a second curved portion which completes the second circuit by contacting the second set of leads.

19. The method of claim 18 and further comprising providing the switching mechanism having an arcuate recess proximate a first end and a recess proximate a second end having an acoustic seal disposed therein.

20. The method of claim 19 and further comprising manipulating the switching mechanism into the first position such that the arcuate recess is disposed about the first acoustic passage placing the first acoustic port of the microphone in an acoustically receptive state and the recess having an acoustic seal in the switching mechanism is positioned apart from the second acoustic passage placing the second port of the microphone in an acoustic receptive state wherein the first curved portion of the first connector connects the first set of leads and thereby completes a first electric circuit wherein the second curved portion of the second connector is positioned apart from the second set of leads thereby breaking the second circuit and manipulating the switching mechanism into the second position such that the switching mechanism is away from the first acoustic passage thereby placing the first acoustic port into an acoustically receptive state wherein the acoustic port seal acoustically seals the second acoustic passage placing the second port of the microphone into an unreceptive acoustic state wherein the second curved portion of the second connector connects the second set of leads and thereby completes a second electric circuit while positioning the first curved portion of the first connector apart from the first set of leads and thereby breaking the first electrical circuit.
